(19) United States
(12) Patent Application Publication
(10) Pub. No.: US 2024/0370114 A1
(43) Pub. Date: Nov. 7, 2024

(54) METHOD AND APPARATUS FOR AUTOMATIC TESTING OF A TOUCH SCREEN

(71) Applicant: GE Precision Healthcare LLC, Wauwatosa, WI (US)

(72) Inventor: Godwin Christopher Selvi, Bengaluru (IN)

(21) Appl. No.: 18/312,379

(22) Filed: May 4, 2023

(51) Int. Cl. G06F 3/041; G06F 3/044

(52) U.S. Cl. CPC G06F 3/0416; G06F 3/0445

(57) ABSTRACT

A system includes a printed circuit board having first and second sides, a switch, and an electrical conductor. The first side provides a conductive surface corresponding to an average human fingertip. The switch is disposed on the second side of the printed circuit board, and is configured to change a state of the conductive surface between a grounded state and a non-grounded state to simulate touch events and non-touch events at one or more touch pixels of a touch screen display when the conductive surface is in contact with the display and adjacent to the one or more touch pixels. The electrical conductor is electrically connected between the conductive planar surface and the switch.

### TECHNICAL FIELD

This disclosure relates generally to displays, and more specifically, to methods and apparatuses for automatic testing of a touch screen.

### BACKGROUND

Many modern displays, which can be described as touch screens, are equipped with touch panels, such that they are sensitive to, and can respond to, touch inputs provided to the display. For example, a user can touch, tap, swipe, or provide other touch inputs to the display, which are registered by the touch panel portion of the display, so that the touch screen display can function as a human input device of a computing system.

A touch screen must be extensively tested for reliability before being put into use, and therefore reliable and efficient testing techniques and apparatuses are needed for performing such testing.

### SUMMARY

In some aspects, the techniques described herein relate to a system for testing an operation of a touch screen display. The system includes a printed circuit board having a first side and a second side, the second side being opposite the first side. The first side includes a conductive planar surface that has a size and geometry corresponding to an average human fingertip that is anticipated to provide touch inputs to the touch screen display by contacting the touch screen display adjacent to one or more touch pixels of the touch screen display. The system includes a switch disposed on the second side of the printed circuit board, where the switch is configured to change a state of the conductive planar surface between a grounded state and a non-grounded state, where a touch event at the one or more touch pixels is simulated when the conductive planar surface is in contact with the touch screen display and adjacent to the one or more touch pixels and is changed from the non-grounded state to the grounded state, and where a non-touch event at the one or more touch pixels is simulated when the conductive planar surface is adjacent to the one or more touch pixels and in the non-grounded state. The system includes an electrical conductor electrically connected between the conductive planar surface and the switch.

Implementations of the system can include one or more of the following features, alone or in any combination with each other.

For example, the switch can include a digital electronic switch disposed on the second side of the printed circuit board and, where the digital electronic switch is configured to be actuated in response to a signal received from a processor to change the state between the grounded state and the non-grounded state.

In another example, the electrical conductor can pass though the printed circuit board from the first side of the printed circuit board to the second side of the printed circuit board.

In another example, the electrical conductor can pass through a via in the printed circuit board.

In another example, the size and geometry of the conductive planar surface can be defined by an etching process that removes conductive material from the first side of the printed circuit board.

In another example, the printed circuit board can electrically isolate the first side from the second side.

In another example, the state of the conductive planar surface, when changed from the non-grounded state to the grounded state can cause a touch event at the one or more touch pixels without moving the conductive planar surface.

In another example, the touch event at the one or more touch pixels is simulated when the conductive planar surface is in contact with the touch screen display and adjacent to the one or more touch pixels and is changed from the non-grounded state to the grounded state and back to the non-grounded state.

In another example, the conductive planar surface is the furthest protruding structure from the first side of the printed circuit board.

In another example, the conductive planar surface is the only conductive planar surface on the first side of the printed circuit board.

In another example, the first side of the printed circuit board includes a plurality of conductive planar surfaces, each conductive planar surface having a size and geometry corresponding to an average human fingertip that is anticipated to provide touch inputs to the touch screen display by contacting the touch screen display adjacent to one or more touch pixels of the touch screen display. The system further includes a plurality of switches disposed on the second side of the printed circuit board, where each switch is configured to change a state of a respective conductive planar surface of the plurality of conductive planar surfaces between a grounded state and a non-grounded state, where a touch event at the one or more touch pixels adjacent to a conductive planar surface associated with a switch is simulated when the conductive planar surface associated with the switch is in contact with the touch screen display and adjacent to the one or more touch pixels and is changed from the non-grounded state to the grounded state, and where a non-touch event at the one or more touch pixels is simulated when the conductive planar surface associated with the switch is in contact with the touch screen display and adjacent to the one or more touch pixels and in the non-grounded state. The system further includes a plurality of electrical conductors, each electrical conductor being electrically connected between a switch of the plurality of switches and a conductive planar surface associated with the switch.

In another example, the system further includes a processor configured for controlling the switch to change the state of the conductive planar surface between a grounded state and a non-grounded state and for receiving data from the touch screen display, the data indicating a response of the one or more touch pixels to a change of state of the conductive planar surface when the conductive planar surface is in contact with the touch screen display and adjacent to the one or more touch pixels.

In some aspects, the techniques described herein relate to a method of testing an operation of a touch screen display. The method includes contacting a conductive planar surface on a first side of a printed circuit board with the touch screen display. The method includes changing a state of the conductive planar surface on the first side of the printed circuit board between a non-grounded state and a grounded state with a switch disposed on a second side of the printed circuit board, the second side being opposite the first side, when the conductive planar surface is in contact with the touch screen display and adjacent to one or more touch pixels of the touch screen display, where a touch event at the one or more touch pixels is simulated when the conductive planar surface adjacent to the one or more touch pixels and is changed from the non-grounded state to the grounded state, where a non-touch event at the one or more touch pixels is simulated when the conductive planar surface is adjacent to the one or more touch pixels and in the non-grounded state, where the switch is electrically connected to the conductive planar surface by an electrical conductor that passes through the printed circuit board from the first side to the second side. The method includes receiving data from the touch screen display in response to the change of state of the conductive planar surface, the data indicating a response of the one or more touch pixels to a change of state of the conductive planar surface when the conductive planar surface is in contact with the touch screen display and adjacent to the one or more touch pixels.

Implementations of the method can include one or more of the following features, alone or in any combination with each other.

For example, the switch can include a digital electronic switch, and the method can further includes providing one or more signals to the digital electronic switch, where the one or more signals cause the digital electronic switch to be activated to change state of the conductive planar surface.

In another example, the electrical conductor can pass through a via in the printed circuit board.

In another example, the a size and geometry of the conductive planar surface can be defined by an etching process that removes conductive material from the first side of the printed circuit board.

In another example, the state of the conductive planar surface, when changed from the non-grounded state to the grounded state can cause a touch event at the one or more touch pixels without moving the conductive planar surface.

In some aspects, the techniques described herein relate to a device for testing an operation of a touch screen display. The device include a printed circuit board including an upper conductive layer, an intermediary insulating layer, and a lower conductive layer, the lower conductive layer consisting of one or more isolated conductive planar surfaces, and one or more switches disposed on the upper conductive layer, wherein each isolated conductive planar surface is in electrical communication with one of the one or more switches.

Implementations of the device can include one or more of the following features, alone or in any combination with each other.

For example, the printed circuit board can provide at least one through-hole extending from the upper layer to the lower layer, and the device can further include: a respective conductive wire extending through each through-hole, each conductive wire electrically connecting a switch of the one or more switches to an associated isolated conductive planar surface of the one or more isolated conductive planar surfaces.

In another example, the one or more isolated conductive planar surfaces can include a plurality of isolated conductive planar surfaces and the one or more switches can include a plurality of switches, where each switch of the plurality of switches is connected to a different isolated conductive planar surface of the plurality of isolated conductive planar surfaces, and where each isolated conductive planar surface of the plurality of isolated conductive planar surfaces is electrically connected to a switch of the plurality of switches.

In another example, the one or more isolated conductive planar surfaces are the only conductive planar surfaces on a lower side of the printed circuit board.

In another example, the one or more isolated conductive planar surfaces are obtained by a process that removes all of the lower layer except for one or more regions that provide the one or more isolated conductive planar surfaces.

In another example, the each isolated conductive planar surface of the one or more isolated conductive planar surfaces is electrically insulated from other isolated conductive planar surfaces of the one or more isolated conductive planar surfaces.

### BRIEF DESCRIPTION OF THE DRAWINGS

FIG. 1 illustrates an example system that includes a touch screen display, according to an implementation.

FIG. 2 provides a graphical representation of different sections of the panel of the touch screen display, in accordance with various aspects of the subject technology.

FIG. 3 is a schematic diagram of an example touch screen display having a stack of a number of different layers, according to an implementation.

FIG. 4 is a schematic diagram of a touch screen having a plurality of touch pixels, according to an implementation.

FIG. 5 is a schematic diagram of a testing system located adjacent to a touch screen that is tested by the system, according to an implementation.

FIG. 6A is a schematic diagram of a bottom view of a printed circuit board having a conductive surface for providing simulated touch events to a touch screen display.

FIG. 6B is a schematic diagram of a cross-section of a portion of the printed circuit board of FIG. 6A taken through line A-A′ of FIG. 6A.

FIG. 6C is a schematic diagram of a cross-section of a portion of the printed circuit board of FIG. 6A taken through line B-B′ of FIG. 6A.

FIG. 6D is a schematic diagram of a bottom view of a printed circuit board having a conductive surface for providing simulated touch events to a touch screen display.

FIG. 6E is a schematic diagram of a cross-section of a portion of the printed circuit board of FIG. 6D taken through line A-A′ of FIG. 6D.

FIG. 7 is a schematic diagram of a circuit of a testing system, according to an implementation.

FIG. 8 is a schematic diagram of a pattern of a plurality of conductive planar surfaces of a testing system, according to an implementation.

FIG. 9 is a schematic diagram of a system for testing an operation of a computing system that includes a touch screen display, according to an implementation.

FIG. 10 is a flowchart of a process for testing an operation of a computing system that includes a touch screen display according to an aspect of the disclosure.

### DETAILED DESCRIPTION

This disclosure relates to techniques and systems for testing an operation of a touch screen display, for example, a projected capacitive (PCAP) touch screen. Touch screen displays include a number of subcomponents, including, for example, a display layer (having additional subcomponents, such as, for example, organic light emitting diodes (OLEDs), thin film transistors (TFTs) used to control the output of the OLEDs and encapsulation layers), a touch sensitive layer, and a cover window layer. The touch sensitive layer provides the touch screen with the ability to detect the presence and location of a touch on the touch screen.

In some implementations, a touch sensitive layer of a touch screen can include a lattice of conducting material, such as indium tin oxide (ITO), which is deposited as a thin film on a substrate (e.g., glass, plastic, etc.). In some implementations, a touch sensitive layer of a touch screen can include a mesh of copper or silver conductive material applied to the backside of the substrate. A pattern of the lattice or mesh can define a plurality of touch pixels in the touch sensitive layer, which may independently sense and respond to touch events on the display, depending on how close the touch pixels are to the location of the touch events.

A touch event can be sensed by a touch pixel by sensing a change in capacitance in a circuit associated with the touch pixel in response to contact on the touch screen near the touch pixel. Then, in response to the sensed change in capacitance, a signal can be provided from the touch pixel to a processor to indicate the occurrence of the touch event at the touch pixel.

A touch sensitive layer can be fabricated and then laminated to other subcomponents of the touch screen display, such as, for example, the display layer, and the cover window layer. Often, the touch sensitive layer is fabricated separately from and by different manufacturers than the display layer and the cover window layer, and then the subcomponents of the touch screen display are integrated in a final assembly process. Although testing of the touch sensitive layer and its constituent touch pixels generally is performed at the time the touch sensitive layer is fabricated, such testing may not be sufficient to validate the final touch screen product or a computing system into which the touch screen display is integrated. Therefore, there is a need for testing an operation of the touch sensitive layer in the final touch screen product or system in an efficient and reliable manner.

Existing techniques and devices used to test touch screen displays can be slow, inaccurate, and expensive. For example, devices that use moving mechanical components to contact the touch screen to simulate a touch event by a human on the touch screen can be expensive, because of the complexities of reliably operating robotic mechanical components. Furthermore, the rate at which touch events on a touch screen under test can be simulated by such a device is limited by the movement of the components of the testing apparatus. In addition, electronic testing devices are prone to inaccuracies, due to the existence of phantom simulated touch events generated on the touch screen that can be generated unintentionally by existing devices.

Therefore, as described herein, techniques and devices that electrically simulate touch events on a touch screen can be used to test a touch screen display. The electrically simulated touch events can be generated by a circuit and system that is inexpensive to create, that operates at a high frequency of simulated touch events, and that reliably provides simulated touch events to the touch screen display with a low probability of generating phantom touch events. In some implementations, the system can include a printed circuit board having a conductive surface for contacting a portion of the touch screen display, and a switch for rapidly switching the conductive surface between a grounded state and an ungrounded state. The length of an electrical path between the conductive surface and the switch can be kept short to decrease a possibility of phantom touch events being generated at the touch screen display by the conductive surface.

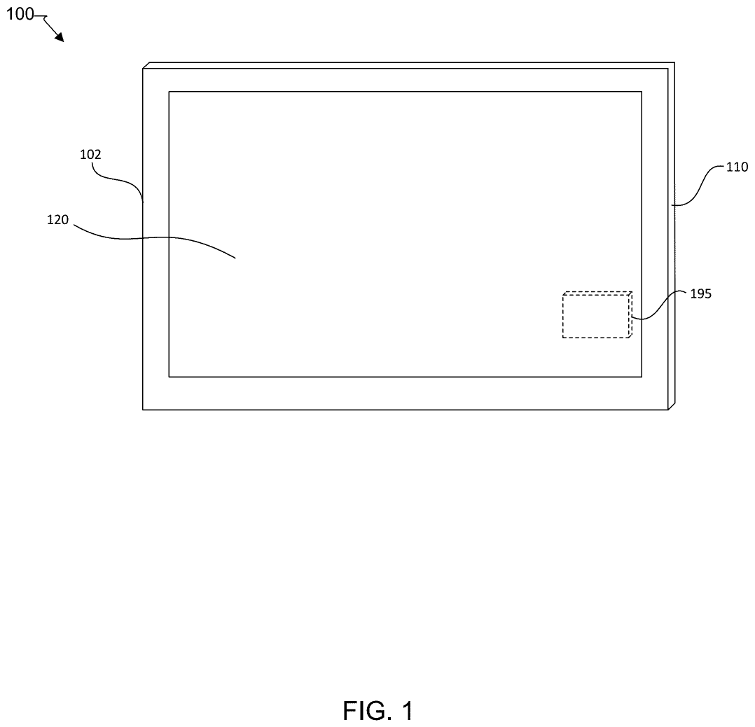

FIG. 1 illustrates an example system 100 that includes a touch screen display 102, according to an implementation. The touch screen display 102 can be formed of a panel that includes active display area 120 and that includes a housing 110, which can back and/or surround (e.g., as a frame) the active display area. The system 100 also can include a controller 195 in the housing 110, where the controller 195 is configured for sensing changes in capacitances in response to contact on the touch-sensitive portion of the touch screen display 102. The controller 195 provides coordinates of the contact on the touch screen display at regular intervals to a processor for processing. The system 100 that includes the touch screen display 102 may include a portable computing device, such as a laptop, a tablet, or a mobile phone, a kiosk, an automobile, a medical device, or any type of computing system.

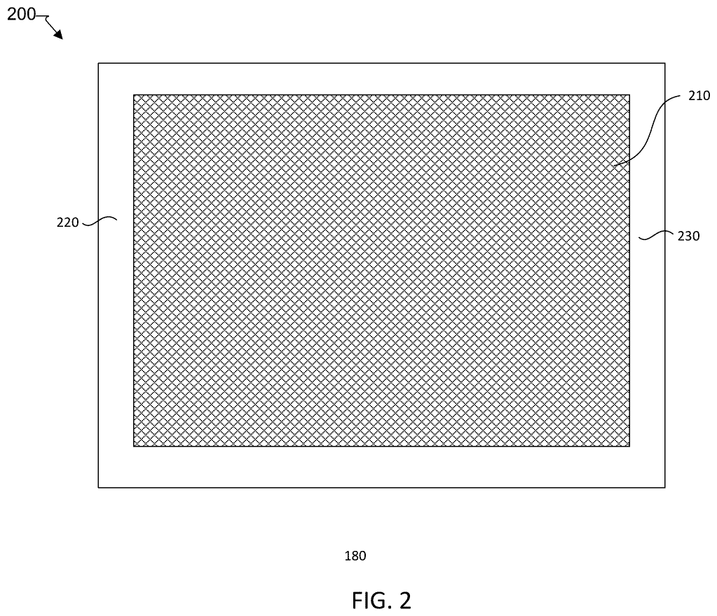

FIG. 2 provides a graphical representation of different sections of the panel of the touch screen, in accordance with various aspects of the subject technology. A touch panel area 210 represents a lattice pattern of conducting material disposed on an area of the panel that corresponds to active display area 120. Because the touch panel area 210 corresponds to active display area 120 that emits light to display visual information on the display, a lattice of transparent conducting material may be used so that illuminated pixels are not obscured. The bezel area 230 of the panel that surrounds the touch panel area over the active display area can provide structural support for the display. The lattice pattern of conductive material can define an array of discrete locations (or “touch pixels”) on the touch sensitive display that can separately and distinctly register touch inputs to the display.

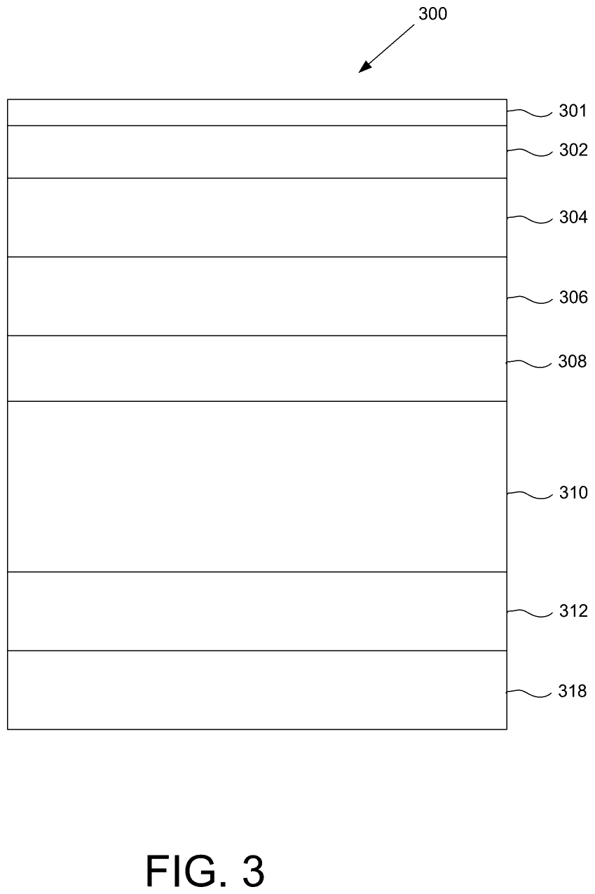

FIG. 3 is a schematic diagram of an example touch screen display 300 having a stack of a number of different layers, according to an implementation. The exemplary stack of layers of the can include, from front to back: a protective film later 301, a cover window layer 302, an optically clear adhesive (OCA) layer 304, a touch-sensitive layer 306, an optically clear adhesive layer 308, a flexible organic light-emitting diode (OLED) layer 310, an adhesive layer 312, and an backplate layer 318. The organic light-emitting diode layer 310 can include, at least, organic light-emitting diode functionality to generate the visual information displayed by the touch sensitive display 300. The touch-sensitive layer 306 can include touch-sensitive elements to detect a user's touch at particular locations (e.g., “touch pixels”) on the touch-sensitive display 306 and to generate electrical signals in response to the detected touch. Furthermore, in some implementations, the organic light-emitting diode layer 310 can include other functional elements of the touch sensitive display 300, such as, for example, TFTs, an encapsulation layer, and anti-reflection optical elements to reduce glare from the display, but in some implementations these functional elements can be included in separate layers from the organic light-emitting diode layer 310. In some implementations, the organic light-emitting diode layer 310 can be coupled to the touch-sensitive layer 306 by the OCA layer 308. The OCA layer 304 can be applied to a front surface of the touch-sensitive layer 306 to couple the touch-sensitive layer 306 to the cover window layer 302 that serves to protect the device on the front side. In some implementations, a polarization layer can be included in the cover window layer 302, or can be included in the organic light-emitting diode layer 310. In general, different adjacent discrete layers of the touch sensitive display 300 can be joined by an adhesive material between the adjacent materials.

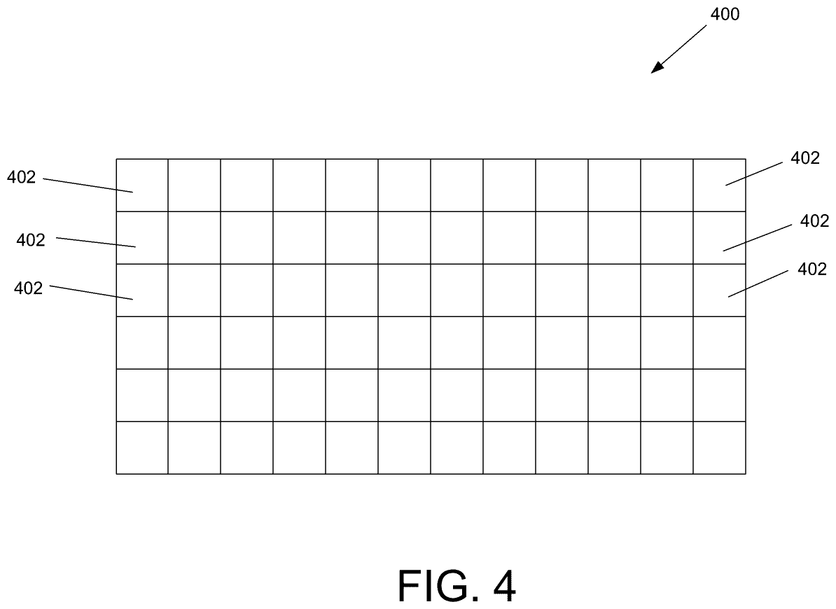

FIG. 4 is a schematic diagram of a touch screen display 400 having a plurality of touch pixels 402, according to an implementation. The touch pixels 402 can be included in a touch sensitive layer of the touch screen display 400 and can be arranged in a regular, two-dimensional pattern or array, for example, a grid pattern. In one implementation, the touch pixels 402 can be arranged in a rectangular grid pattern. Each touch pixel 402 can be configured for sensing a touch input to a portion of the touch screen display 400 associated with the touch pixel. In response to sensing a touch input, a touch pixel 402 can communicate a signal to one or more processors associated with the display 400, and the signal can be used by the one or more processors to perform one or more functions in response to the sensing of the touch input.

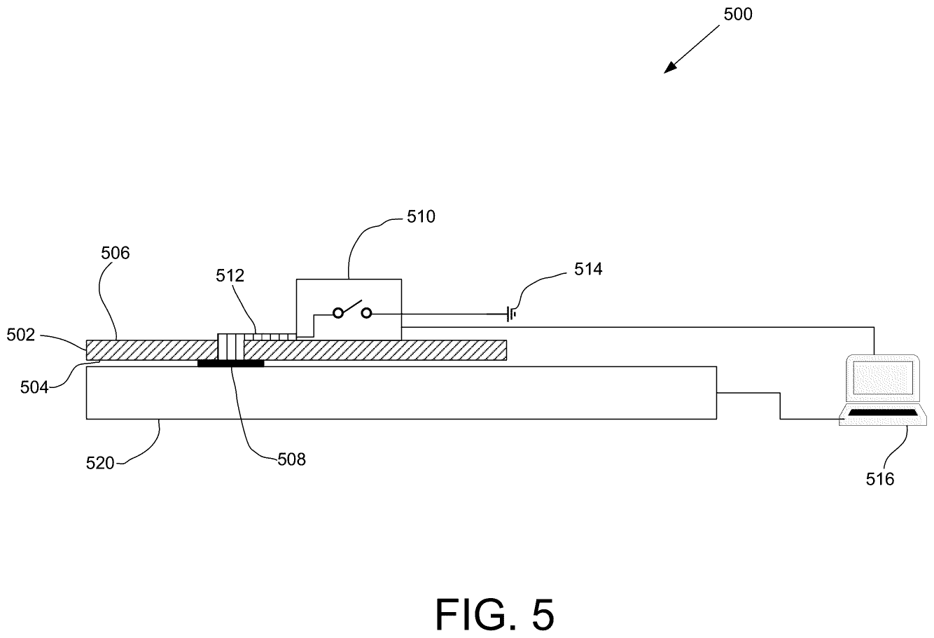

FIG. 5 is a schematic diagram of a testing system 500 positioned in contact with a touch screen display 520 that is tested by the system 500, according to an implementation. The testing system 500 is configured for testing an operation of the touch screen display 520, which includes a plurality of touch pixels, by generating electrical signals that simulate touch events and non-touch events at one or more touch pixels of the touch screen display 520.

The system 500 includes a printed circuit board 502, which has a first side 504 and a second side 506, where the second side is opposite the first side, and a non-conducting layer between the first side and the second side, which electrically isolates the first side from the second side. The first side 504 includes a conductive planar surface 508 that has a size and geometry, such that it can be disposed in contact with the touch screen display and adjacent to one or more touch pixels at the touch screen display 520 (i.e., adjacent to those touch pixels that are located below the surface of the touch screen display directly below the conductive planar surface 508). The conductive planar surface 508 can include a metal material, such as, for example, gold, silver, copper, aluminum, or any material that is electrically conductive. The size and geometry of the conductive planar surface 508 can be defined by a material removal process (e.g., etching, abrasion, etc.) applied to conductive material on the first side 504 of the printed circuit board 502. For example, the printed circuit board 502 can include a non-conductive layer between a first conductive layer on the first side 504 and a second conductive layer on the second side 506 of the printed circuit board 502, and then material of the first conductive layer can be etched away to define the conductive planar surface 508 with a predetermined size and geometry. The size and geometry of the conductive planar surface 508 can correspond, in some implementations, to a size and geometry of a typical, or expected, physical touch input to the touch screen display 520. For example, the size and geometry of the conductive planar surface 508 can correspond to an average human fingertip that is anticipated to provide touch inputs to the touch screen display 520. In some implementations, an area of the conductive planar surface 508 can be less than five square centimeters or less than two square centimeters. In some implementations, the conductive planar surface 508 may be a planar surface having a surface area similar to a fingertip. A plane on which the planar surface lies may be parallel to one or more layer interfaces of the of the printed circuit board 502.

While the printed circuit board 502 is described as including a first side 504 and a second side 506, the printed circuit board 502 may include more than two layers on its first and second sides. For example, in some implementations, the printed circuit board 502 may include inner layers with conductive traces for providing other signals to the touch screen display 520 or to other components. In some implementations, an inner layer of the printed circuit board 502 can include conductive traces that are used to route electrical signals between the conductive planar surface 508 on the first side 504 and one or more electrical elements on the second side 506.

The system 500 can further include a switch 510 disposed on the second side 506 of the printed circuit board 502, and the switch 510 can be electrically connected to an electrical ground 514 and to the conductive planar surface 508 by an electrical connector 512. The electrical connector 512 can pass from the second side 506 to the first side 504 using a number of different structures or techniques. For example, the electrical connector 512 can include a via (e.g., a metal-plated through hole) in the printed circuit board 502 from the second side 506 to the first side 504, or a plated through hole pad, or a combination of buried vias with tracks, etc. to make an electrical connection between the switch 510 and the conductive planar surface 508. To reduce a probability of charge build-up on the conductive planar surface 508, which may cause an unintended, or phantom, touch events to be perceived by the touch pixels (e.g., due to a falsely perceived ground state of the conductive surface 508), an electrical path length of the electrical connector 512 between the switch 510 and the conductive planar surface 508 can be relatively short, for example, less than five centimeters, less than two centimeters, less than one centimeter, or less than five millimeters. By keeping the electrical path length of the electrical connector 512 between the switch 510 and the conductive planar surface 508 relatively short, the system 500 can reliably provide simulated touch events to a touch screen display being testing, with very few, or no, phantom touch events.

In some implementations, when the switch 510 is closed to connect the conductive planar surface to the electrical ground 514, a touch event at the one or more touch pixels adjacent to the conductive planar surface 508 can be simulated. When the switch 510 is open, such that the conductive planar surface 508 can float at a potential not equal to ground, a non-touch event at the one or more touch pixels adjacent to the conductive planar surface 508 can be simulated. Thus, touch events and non-touch events can be simulated by changing the electrical state of the conductive planar surface between a grounded state and a non-grounded state and without physically moving the conductive planar surface 508 or other components of the system 500. By changing the electrical state of the conductive planar surface 508, rather than physically moving the conductive planar surface 508, to simulate touch and non-touch events in the touch pixels, a high cycle rate of simulating touch and non-touch events in the touch pixels can be achieved. For example, more than 50,000 events, or more than 100,000 events, can be simulated per day.

In some implementations, a touch event on certain touch screen displays is simulated by a cycle of changing the first conductive planar surface 508 from the non-grounded state to the grounded state and then back to the non-grounded state. Such a cycle can simulate a “release event”, in which a finger of a user touches the touch screen display and then the finger is removed from touching the touch screen display. The time period for which the conductive planar surface needs to be in the grounded state can depend on the touch screen scanning interval to register a touch event.

A processor 516 can provide signals to the switch 510 to control the state of the switch 510 between a closed state and an open state, such that the state of the conductive planar surface 508 is changed between a grounded state and a non-grounded state. In response to the state of the conductive planar surface 508, the response of the one or more touch pixels adjacent to the conductive planar surface 508 can be monitored, and data received from the touch screen display 520 at the processor 516 can be analyzed to determine a response of the touch screen display 520 to the simulated touch and non-touch events provided by the conductive planar surface 508 to the one or more touch pixels.

Thus, the system 500 can provide simulated touch events to touch pixels of the touch screen display, which are adjacent to the conductive planar surface 508, without moving any parts of the printed circuit board 502 or its components. Indeed, the printed circuit board 502 and its components can include no moving parts at all. Because of the simple architecture and the lack of moving parts, the system 500 and the printed circuit board 502 and its components can be easy and inexpensive to make and maintain. In addition, the system 500 and the printed circuit board 502 and its components can be easily loaded into a testing chamber to test a touch screen display under extreme conditions, for example, in high or low temperatures, in high humidity, in dusty atmospheres, etc.

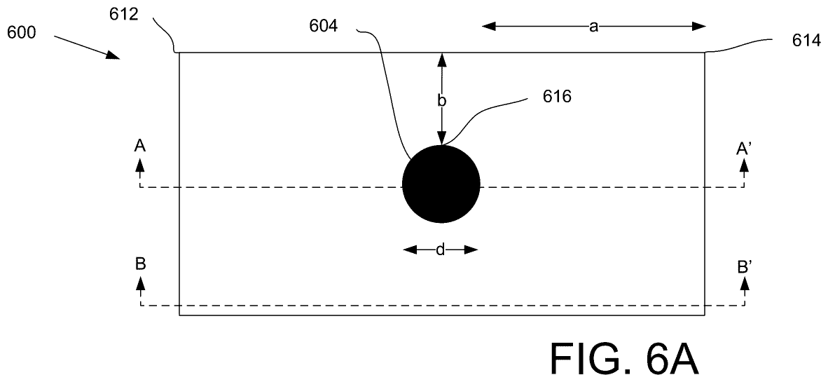

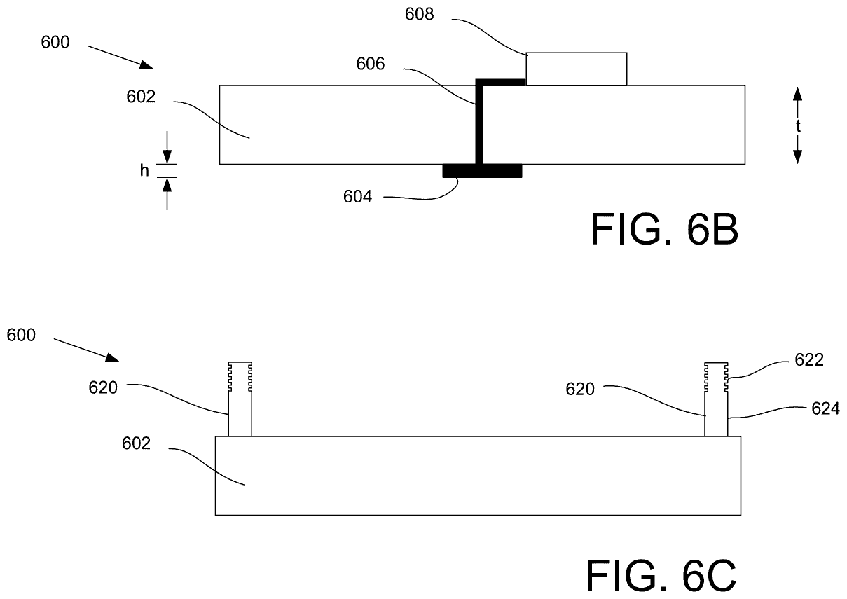

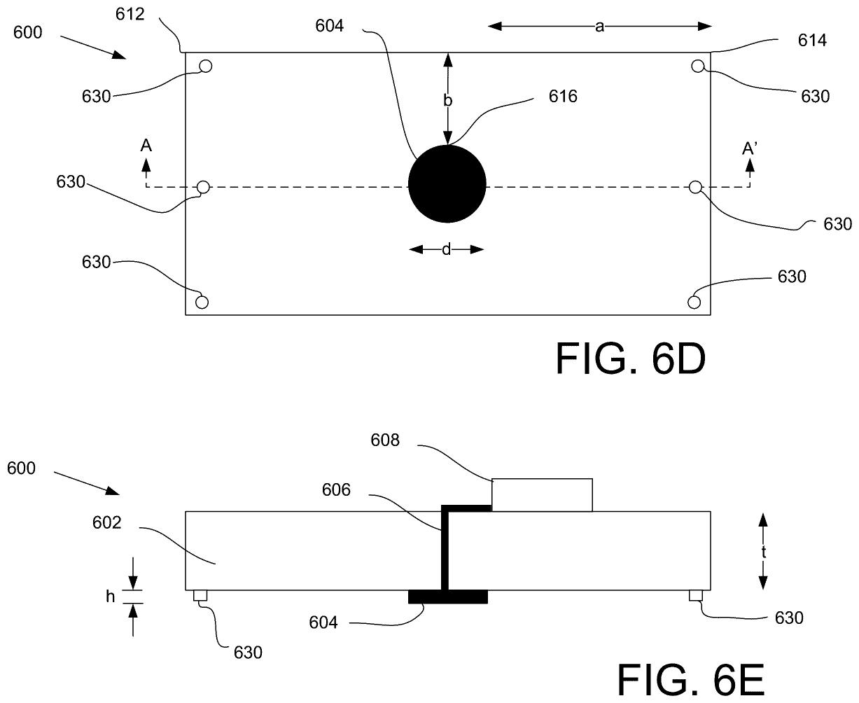

FIG. 6A is a schematic diagram of a bottom view of a printed circuit board 600 having a conductive surface 604 for providing simulated touch events to a touch screen display. FIG. 6B is a schematic diagram of a cross-section of a portion of the printed circuit board of FIG. 6A taken through line A-A′ of FIG. 6A. FIG. 6C is a schematic diagram of a cross-section of a portion of the printed circuit board of FIG. 6A taken through line B-B′ of FIG. 6A. The printed circuit board 600 can be a multi-layer board having a first side that includes the conductive surface 604 and having a second side that includes one or more electronic devices 608 configured for controlling a state of the conductive surface between a grounded state and an ungrounded state. The first side and the second side can be separated physically by an insulating layer 602 that has a thickness, t. The thickness, t, of the printed circuit board 600 can be a standard thickness, such as, for example, 0.78 mm, 1.57 mm, 2.36 mm, or can be a custom thickness. In some implementations, the insulating layer 602 can include a glass-reinforced laminate material, such as, for example, G-10, G-11, FR-4, FR-5, or FR-6 glass epoxy. The one or more electronic devices 608 can be electrically connected to the conductive surface 604 by an electrical connector 606 that can pass through the insulating layer 602.

The printed circuit board 604 can be made originally with a layer of conductive material (e.g., copper) that covers the first side of the printed circuit board, and then the conductive surface 604 on the first side of the printed circuit board 600 can be made by etching away conductive material on the first side of the board to leave only the conductive surface 604 remaining of the original layer of conductive material. The height, h, of the conductive surface 604 that protrudes above the insulating layer 602 can be determined by the amount of conductive material used to form the conductive layer of the first surface. For example, a one ounce per square meter layer of copper results in a height, h, of the conductive surface 604 of 35 micrometers. A two ounce per square meter layer of copper results in a height, h, of the conductive surface 604 of 70 micrometers. A three ounce per square meter layer of copper results in a height, h, of the conductive surface 604 of 104 micrometers. In some implementations, the conductive surface 604 is the furthest protruding structure from the first side of the printed circuit board 600. In some implementations, the conductive surface 604 is the only conductive planar surface on the first side of the printed circuit board 604.

In some implementations, the printed circuit board 600 can have a rectangular shape having dimensions of, for example, at least 5 cm by at least 8 cm. In some implementations, the conductive surface 604 can be configured in a circular shape having a diameter, d. In some implementations, the conductive surface 604 can be located a distance, b, from a nearest edge of the printed circuit board 600 from the conductive surface 604 and can be located a distance, a, from a farthest edge of the printed circuit board 600 from the conductive surface 604.

While the printed circuit board 600 and the conductive surface 604 are designed such that the entire conductive surface 604 contacts a touch screen display to provide simulated touch events to the touch screen display, there may be situations in which less than the entire conductive surface 604 makes contact with the touch screen display. However, even in such situations, the geometry of the printed circuit board and the conductive surface can be designed such that the entire conductive surface 604 can be placed within a threshold distance of the surface of the touch screen display to generate touch events at touch pixels adjacent to the entire surface of the conductive surface 604. For example, when the height, h, of the conductive surface above the insulating surface is small compared to the dimensions of the printed circuit board, for example, when t is less than 1/100^{th} of a or b, then when the printed circuit board 600 is placed against a flat surface of a touch screen display, all of the conductive surface 604 can remain in contact with, or very close, to the surface of the touch screen display.

For example, if the printed circuit board 600 contacts the surface of the touch screen display at corners 612, 614 of the board and the top edge 616 of the conductive surface 604, and the height, h, of the protrusion of the conductive surface 604 above the insulating layer 602 is 104 micrometers (corresponding to the use of a 3 ounce copper layer on the first side of the printed circuit board), and the distance, b, is 2 cm, then the plane of the circuit board would be angled with respect to the surface of the touch screen display by only

$${sin}^{- 1} ( \frac{0.104}{20} ) = 0.3$$

degrees. Then, a conductive surface 604 having a diameter, d, of one centimeter would be no more than 0.052 mm away from the touch screen display surface at the portion of the conductive surface that is most distant from point 616. Thus, the entire surface of the conductive surface 604 would be sufficiently close to touch pixels within the touch screen display, which are adjacent to the conductive surface, such that touch events at the adjacent touch pixels could be simulated. When the height, h, of the protrusion of the conductive surface 604 above the insulating layer 602 is less than 104 micrometers (e.g., 35 micrometers or 70 micrometers, corresponding to the use of a 1 ounce or 2 ounce copper layer on the first side of the printed circuit board, respectively), then the plane of the circuit board would be angled with respect to the surface of the touch screen display by less than 0.3 degrees. For example, using the parameters from the calculation above, but with a 1 ounce copper layer, the plane of the circuit board would be angled with respect to the surface of the touch screen display by less only 0.1 degrees, and a conductive surface having a diameter of one centimeter would be no more than 0.017 mm away from the touch screen display surface at the portion of the conductive surface that is most distant from point 616.

In some implementations (e.g., as shown in FIG. 6C), structural standoffs 620 can be attached to the second side of the printed circuit board 600, for example, in the corners of the second side of the printed circuit board. In some implementations, the standoffs 620 can be cylindrically shaped and can include an unthreaded portion 624 proximate to the second side of the printed circuit board 600 and a threaded portion 622 distal from the second side of the printed circuit board 600. In some implementations, the standoffs 620 can be used to secure the printed circuit board 600 to another component of a system, such as, for example, a robotically-controlled arm used to position the printed circuit board. The standoffs 620 can be metallic or non-metallic.

In another implementation, the printed circuit board 600 can include a plurality of spacers on its first side, which are configured for keeping a plane of the printed circuit board parallel to the surface of the touch screen display under test when the conductive surface 604 contacts the touch screen display to ensure that the entire surface of the conductive surface contacts, or is very close to, the touch screen display. FIG. 6D is a schematic diagram of a bottom view of a printed circuit board 600 having a conductive surface 604 that protrudes from insulating layer 602 and is configured for providing simulated touch events to a touch screen display. FIG. 6E is a schematic diagram of a cross-section of a portion of the printed circuit board of FIG. 6D taken through line A-A′ of FIG. 6D. The printed circuit board 600 of FIG. 6D and FIG. 6E also includes a plurality of spacers 630 that protrude from the insulating layer 602 and that have heights that are equal to or slightly less than the height, h, of the conductive surface 604. For example, the heights of the spacers can be equal to the height of the conductive surface 604, or less than 95% of the height of the conductive surface 604, or less than 90% of the height of the conductive surface 604, or less than 80% of the height of the conductive surface 604. The plurality of spacers 630 can be arranged near the perimeter of the first side of the printed circuit board to act as feet that maintain the printed circuit board parallel to surface of the touch screen display under test withing a threshold tolerance (e.g., less than 0.1 degree angular error, less than 0.03 degree angular error, less than 0.01 degree angular error) when the conductive surface 604 contacts the touch screen display.

In some implementations, the plurality of spacers 630 can be fabricated from the same conductive material on the first side of the printed circuit board that is used to form the conductive surface 604. For example, the conductive surface 604 and the plurality of spacers 630 can be fabricated by etching away material of the conductive layer on the first side of the printed circuit board 600 to leave the conductive surface 604 and the plurality of spacers 630 remaining from the original layer of conductive material on the first side of the printed circuit board. In some implementations, the plurality of spacers 630 can be made of non-conductive material. For example, non-conductive material can be deposited on, or adhered to, the printed circuit board to form the spacers 630.

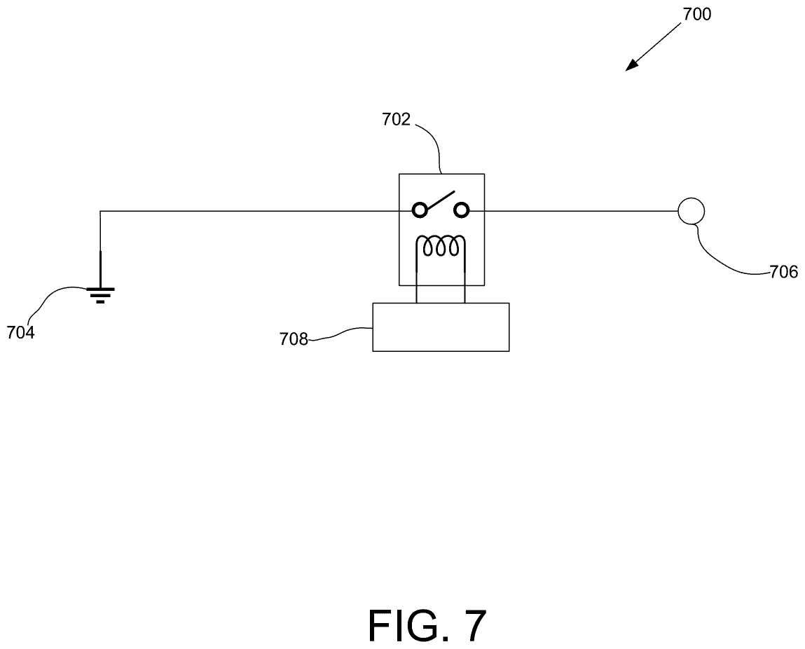

FIG. 7 is a schematic diagram of an example circuit 700 of a testing system, according to an implementation. The circuit 700 includes a switch 702 (e.g., a SPDT switch) that can be switched between a connected state and an unconnected state between an electrical ground 704 on one side of the switch and a conductive planar surface 706 on the other side of the switch. The state of the switch 702 can be used to change the state of the conductive planar surface 706 between a grounded and non-grounded state and thereby to simulate touch events and non-touch events, respectively, at one or more touch pixels adjacent to the conductive planar surface 706. The state of the switch 702 can be controlled remotely by a controller 708 that is configured to provide electrical signals to change the state of the switch 702. In some implementations, the switch 702 can include a digital electronic switch (e.g., a field effect transistor), and the electrical signals provided by the controller 708 can be used to control the state of the digital electronic switch, where the electrical signals change the state of the digital electronic switch from conducting to non-conducting to cause a change of the state of the switch 702. In some implementations, the switch 702 can include an electromechanical switch, for example, including a relay,

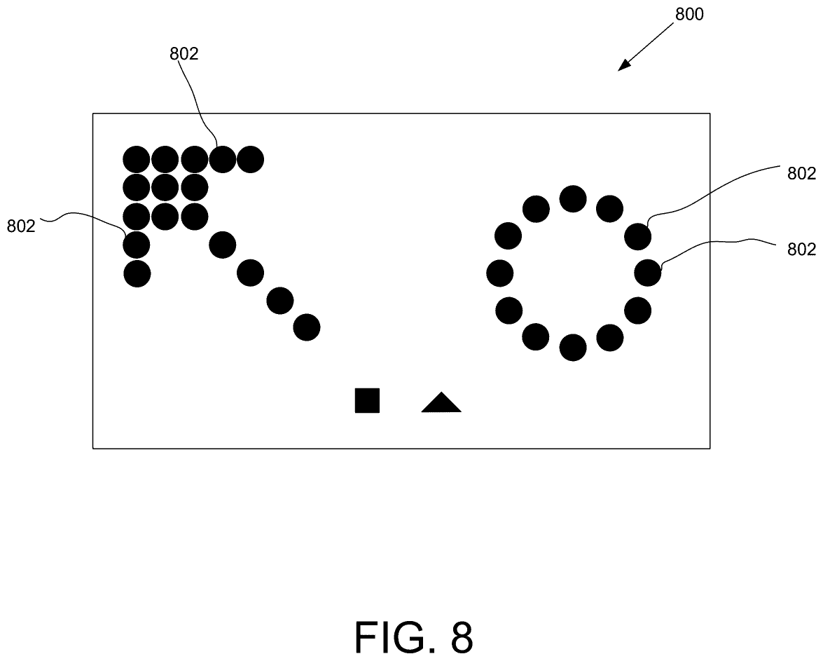

FIG. 8 is a schematic diagram of a pattern 800 of a plurality of conductive planar surfaces 802 of a testing system, according to an implementation, where the plurality of conductive planar surfaces 802 are used to simulate touch and non-touch events at different touch pixels of a touch screen display. The plurality of conductive planar surfaces 802 can be defined in a first side of a printed circuit board, for example, by selectively removing conductive material from the first side to define the pattern of conductive planar surfaces 802. Each conductive planar surface 802 of the plurality of conductive planar surfaces in the pattern 800 can be coupled to a switch that controls a state of the conductive planar surface between a grounded and ungrounded state. In some implementations, each conductive planar surface 802 of the pattern can be connected to a different switch. In some implementations, more than one conductive planar surface 802 of the pattern can be connected to a single multi-throw switch, so that one switch can be used to switch different conductive planar surfaces 802 between a non-grounded state and a grounded state. A processor can control the switches that switch the plurality of conductive planar surfaces 802 between grounded and non-grounded states, and the processor can further control the timing of the control to simulate dynamic touch events at different touch pixels of a touch screen display. In this manner, dynamic (e.g., swipe) gestures on the touch screen display can be simulated. For example, the processor can control the timing of the grounding of different conductive planar surfaces 802 in the circle of the pattern 800, such that a circular swipe gesture on the touch screen display is simulated. Similarly, the processor can control the timing of the grounding of different conductive planar surfaces 802 in the arrow of the pattern 800, such that a directional gesture on the touch screen display is simulated.

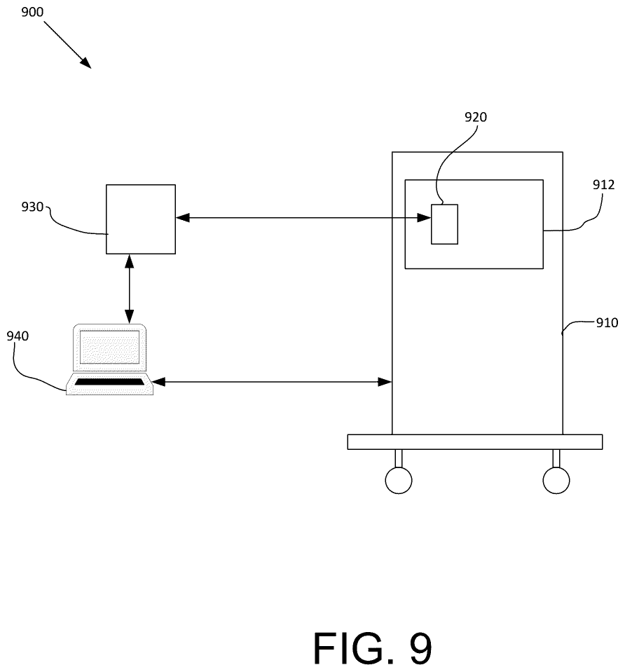

FIG. 9 is a schematic diagram of a system 900 for hardware-in-the-loop (HIL) testing an operation of a computing system 910 that includes a touch screen display 912, according to an implementation. The computing system 910 can be designed, for example, to receive human input through the touch screen display 912 and to respond to the received input. The system 900 is configured to test the response of the computing system 910 to many simulated touch events provided to the touch screen display 912 to determine if the touch screen display 912 and the computing system perform as designed.

The system 900 includes testing circuitry 920 located on a second side of a printed circuit board and includes one or more conductive planar surfaces located on a first side of the printed circuit board and configured to be placed adjacent to touch pixels of the touch screen display 912, so that the testing circuitry 920 can be used to simulate touch events and non-touch events at the touch pixels. Signals to control the testing circuitry 920 can be provided from a control board 930, which is controlled by a processor 940. The processor 940 also is configured to receive data from the computing system, where the received data indicates a response of the touch screen display 912 and/or the computing system 910 to the simulated touch events and non-touch events that are provided to the touch screen display 912.

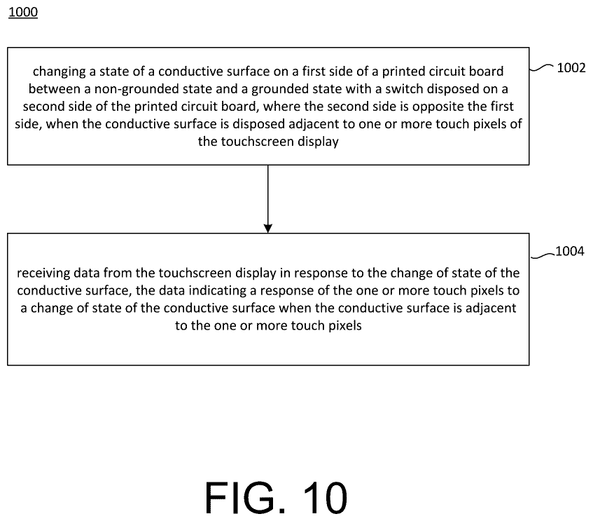

FIG. 10 is a flowchart of a process 1000 for testing an operation of a computing system that includes a touch screen display according to an aspect of the disclosure. The process 1000 includes changing a state of a conductive planar surface on a first side of a printed circuit board between a non-grounded state and a grounded state with a switch disposed on a second side of the printed circuit board, where the second side is opposite the first side, when the conductive planar surface is disposed adjacent to one or more touch pixels of the touch screen display (1002). When the conductive planar surface adjacent to the one or more touch pixels and is changed from the non-grounded state to the grounded state a touch event at the one or more touch pixels is simulated, and a non-touch event at the one or more touch pixels is simulated when the conductive planar surface is adjacent to the one or more touch pixels and in the non-grounded state. The switch is electrically connected to the conductive planar surface by an electrical conductor that passes through the printed circuit board from the first side to the second side. The process 1000 further includes receiving data from the touch screen display in response to the change of state of the conductive planar surface, the data indicating a response of the one or more touch pixels to a change of state of the conductive planar surface when the conductive planar surface is adjacent to the one or more touch pixels (1004).

Some of the above example implementations are described as processes or methods depicted as flowcharts. Although the flowcharts describe the operations as sequential processes, many of the operations may be performed in parallel, concurrently, or simultaneously. In addition, the order of operations may be re-arranged. The processes may be terminated when their operations are completed but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, be embodied in many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

The terminology used herein is for the purpose of describing particular implementations only and is not intended to be limiting of example implementations. As used herein, the singular forms a, an, and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations not limited by these aspects of any given implementation.

Detailed implementations are disclosed herein. However, it is understood that the disclosed implementations are merely examples, which may be embodied in various forms. Therefore, specific structural and functional details disclosed herein are not to be interpreted as limiting, but merely as a basis for the claims and as a representative basis for teaching one skilled in the art to employ the implementations in virtually any appropriately detailed structure. Further, the terms and phrases used herein are not intended to be limiting, but to provide an understandable description of the present disclosure.

It should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time. Additionally, while certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations.

What is claimed is:

1. A system for testing an operation of a touch screen display, the system comprising:
a printed circuit board having a first side and a second side, the second side being opposite the first side, wherein the first side provides a conductive planar surface that has a size and geometry corresponding to an average human fingertip that is anticipated to provide touch inputs to the touch screen display by contacting the touch screen display adjacent to one or more touch pixels of the touch screen display;
a switch disposed on the second side of the printed circuit board, wherein the switch is configured to change a state of the conductive planar surface between a grounded state and a non-grounded state, wherein a touch event at the one or more touch pixels is simulated when the conductive planar surface is in contact with the touch screen display and adjacent to the one or more touch pixels and is changed from the non-grounded state to the grounded state, and wherein a non-touch event at the one or more touch pixels is simulated when the conductive planar surface is adjacent to the one or more touch pixels and in the non-grounded state; and
an electrical conductor electrically connected between the conductive planar surface and the switch.

2. The system of claim 1, wherein the switch includes a digital electronic switch disposed on the second side of the printed circuit board and, wherein the digital electronic switch is configured to be actuated in response to a signal received from a processor to change the state between the grounded state and the non-grounded state.

3. The system of claim 1, wherein the electrical conductor passes though the printed circuit board from the first side of the printed circuit board to the second side of the printed circuit board.

4. The system of claim 3, wherein the electrical conductor passes through a via in the printed circuit board.

5. The system of claim 1, wherein the size and geometry of the conductive planar surface is defined by an etching process that removes conductive material from the first side of the printed circuit board.

6. The system of claim 1, wherein the printed circuit board electrically isolates the first side from the second side.

7. The system of claim 1, wherein the state of the conductive planar surface, when changed from the non-grounded state to the grounded state causes a touch event at the one or more touch pixels without moving the conductive planar surface.

8. The system of claim 1, wherein the touch event at the one or more touch pixels is simulated when the conductive planar surface is in contact with the touch screen display and adjacent to the one or more touch pixels and is changed from the non-grounded state to the grounded state and back to the non-grounded state.

9. The system of claim 1, wherein the conductive planar surface is the furthest protruding structure from the first side of the printed circuit board.

10. The system of claim 1, wherein the conductive planar surface is the only conductive planar surface on the first side of the printed circuit board.

11. The system of claim 1, wherein the first side of the printed circuit board includes a plurality of conductive planar surfaces, each conductive planar surface having a size and geometry corresponding to an average human fingertip that is anticipated to provide touch inputs to the touch screen display by contacting the touch screen display adjacent to one or more touch pixels of the touch screen display, the system further comprising:
a plurality of switches disposed on the second side of the printed circuit board, wherein each switch is configured to change a state of a respective conductive planar surface of the plurality of conductive planar surfaces between a grounded state and a non-grounded state, wherein a touch event at the one or more touch pixels adjacent to a conductive planar surface associated with a switch is simulated when the conductive planar surface associated with the switch is in contact with the touch screen display and adjacent to the one or more touch pixels and is changed from the non-grounded state to the grounded state, and wherein a non-touch event at the one or more touch pixels is simulated when the conductive planar surface associated with the switch is in contact with the touch screen display and adjacent to the one or more touch pixels and in the non-grounded state; and
a plurality of electrical conductors, each electrical conductor being electrically connected between a switch of the plurality of switches and a conductive planar surface associated with the switch.

12. The system of claim 1, further comprising a processor configured for controlling the switch to change the state of the conductive planar surface between a grounded state and a non-grounded state and for receiving data from the touch screen display, the data indicating a response of the one or more touch pixels to a change of state of the conductive planar surface when the conductive planar surface is in contact with the touch screen display and adjacent to the one or more touch pixels.

13. A method of testing an operation of a touch screen display, the method comprising: contacting a conductive planar surface on a first side of a printed circuit board with the touch screen display;
changing a state of the conductive planar surface on the first side of the printed circuit board between a non-grounded state and a grounded state with a switch disposed on a second side of the printed circuit board, the second side being opposite the first side, when the conductive planar surface is in contact with the touch screen display and adjacent to one or more touch pixels of the touch screen display,
wherein a touch event at the one or more touch pixels is simulated when the conductive planar surface adjacent to the one or more touch pixels and is changed from the non-grounded state to the grounded state,
wherein a non-touch event at the one or more touch pixels is simulated when the conductive planar surface is adjacent to the one or more touch pixels and in the non-grounded state,
wherein the switch is electrically connected to the conductive planar surface by an electrical conductor that passes through the printed circuit board from the first side to the second side; and
receiving data from the touch screen display in response to the change of state of the conductive planar surface, the data indicating a response of the one or more touch pixels to a change of state of the conductive planar surface when the conductive planar surface is in contact with the touch screen display and adjacent to the one or more touch pixels.

14. The method of claim 13, wherein the switch includes a digital electronic switch, and the method further comprising:
providing one or more signals to the digital electronic switch, wherein the one or more signals cause the digital electronic switch to be activated to change state of the conductive planar surface.

15. The method of claim 13, wherein the electrical conductor passes through a via in the printed circuit board.

16. The method of claim 13, wherein a size and geometry of the conductive planar surface is defined by an etching process that removes conductive material from the first side of the printed circuit board.

17. The method of claim 13, wherein the state of the conductive planar surface, when changed from the non-grounded state to the grounded state causes a touch event at the one or more touch pixels without moving the conductive planar surface.

18. A device for testing an operation of a touch screen display, the device comprising:
a printed circuit board comprising an upper conductive layer, an intermediary insulating layer, and a lower conductive layer, the lower conductive layer consisting of one or more isolated conductive planar surfaces; and
one or more switches disposed on the upper conductive layer,
wherein each isolated conductive planar surface is in electrical communication with one of the one or more switches.

19. The device of claim 18, wherein the printed circuit board provides at least one through-hole extending from the upper layer to the lower layer, the device further comprising:
a respective conductive wire extending through each through-hole, each conductive wire electrically connecting a switch of the one or more switches to an associated isolated conductive planar surface of the one or more isolated conductive planar surfaces.

20. The device of claim 19, wherein the one or more isolated conductive planar surfaces comprises a plurality of isolated conductive planar surfaces and the one or more switches comprises a plurality of switches,
wherein each switch of the plurality of switches is connected to a different isolated conductive planar surface of the plurality of isolated conductive planar surfaces, and
wherein each isolated conductive planar surface of the plurality of isolated conductive planar surfaces is electrically connected to a switch of the plurality of switches.

21. The device of claim 18, wherein the one or more isolated conductive planar surfaces are the only conductive planar surfaces on a lower side of the printed circuit board.

22. The device of claim 18, wherein the one or more isolated conductive planar surfaces are obtained by a process that removes all of the lower layer except for one or more regions that provide the one or more isolated conductive planar surfaces.

23. The device of claim 18, wherein each isolated conductive planar surface of the one or more isolated conductive planar surfaces is electrically insulated from other isolated conductive planar surfaces of the one or more isolated conductive planar surfaces.
